(19) United States
(12) Patent Application Publication
(10) Pub. No.: US 2019/0124861 A1
(43) Pub. Date: May 2, 2019

(54) Fluid Emitter concepts for feeding the root system of a plant

(71) Applicant: Matthews John, Tucson, AZ (US)

(72) Inventor: Matthews John, Tucson, AZ (US)

(21) Appl. No.: 15/732,383

(22) Filed: Nov. 2, 2017

(51) Int. Cl. A01G 29/00; A01G 1/00; A01G 27/00; B28B 1/26

(52) U.S. Cl. CPC A01G 29/00; A01G 1/001; B28B 19/0038; A01G 27/008; B28B 1/264; A01G 27/006

(57) ABSTRACT

The present invention provides a new and useful (i) plant root feeding device (ii) plant root feeding system, (iii) method of feeding a plant, and (iv) method of manufacturing a plant root feeding device. The plant root feeding device comprises a fluid container (emitter) formed of semi permeable material that allows fluid to pass from the inside of the container to a plant root located in ground in proximity to the fluid container. The fluid container has a fluid inlet opening, and a fluid inlet tube is in fluid communication with the fluid inlet opening of the fluid container. The fluid inlet tube has a fixed, fluid sealed coupling to the fluid inlet opening of the fluid container, and the fluid container has a configuration that enables it to be located in ground in proximity to an in ground root system of a plant, and a permeability that enables fluid to pass from the inside of the container to the in ground root system of a plant in proximity to the fluid container.

This is a continuation of U.S. patent application Ser. No. 14/619,734, filed on Feb. 11, 2015, inventor John Matthews, and entitled “Fluid Emitter Concept for Feed the Root System of a Plant”.

### BACKGROUND

The present invention relates to new and useful concepts in fluid emitters designed to feed the root system of a plant. These concepts are designed to provide efficient and economical feeding of the root system a plant, without a complicated irrigation system, and without the need to saturate the soil in which the plant root system is provided. The fluid emitter concept of the present invention is designed to provide the root system of a plant with the fluid it needs, and is seeking, when the root system needs the fluid, and in a manner that does not waste the fluid. The fluid may be just water, but can also be a mixture of water and plant food that is dissolved or suspended in the water.

### SUMMARY OF THE INVENTION

The present invention provides a new and useful (i) plant root feeding device (ii) plant root feeding system, (iii) method of feeding a plant, and (iv) method of manufacturing a plant root feeding device.

The plant root feeding device comprises a fluid container (emitter) formed of semi permeable material that allows fluid to pass from the inside of the container to a plant root located in ground in proximity to the fluid container. The fluid container has a fluid inlet opening, and a fluid inlet tube is in fluid communication with the fluid inlet opening of the fluid container. The fluid inlet tube has a fixed, fluid sealed coupling to the fluid inlet opening of the fluid container, and the fluid container has a configuration that enables it to be located in ground in proximity to an in-ground root system of a plant, and a permeability that enables fluid to pass from the inside of the container to the in ground root system of a plant in proximity to the fluid container.

In this application reference to the fluid container (emitter) being in “proximity” to an inground root system of a plant means that the fluid container is within 5 inches of the in ground root system of the plant.

In a plant root feeding device according to the present invention, the fluid container (emitter) preferably has a ball shaped configuration. Also, the fluid container is formed of semi permeable ceramic material. Moreover, the fluid inlet opening has a ceramic collar that has a sealed, substantially permanent connection with the fluid container, and the fluid inlet tube is integrally connected with the ceramic collar. In addition, the ceramic container has a predetermined wall thickness, and the ceramic collar has a thickness that is larger than the predetermined wall thickness of the ceramic container. The ball shaped container has an outer diameter in the range of 1.5 inches to 5 inches and a wall thickness in the range of 0.25 inches to ½ inches, and the ratio of the outer diameter of the container to the wall thickness is about 20 to 1. The ceramic material is barium free, and the ceramic material includes sodium silicate.

In a plant root feeding system, according to the present invention, the fluid container is located in proximity to the in ground root system of a plant, the fluid container allows fluid to pass from the inside of the container to the in ground root system of the plant, the fluid container having a fluid inlet opening, and the fluid inlet tube has a distal end in fluid communication with a source of plant feeding fluid.

In a method of feeding a plant root, according to the present invention, the plant root feeding system, as described above, is provided, with the fluid container located in proximity to the in ground root system of the plant, and plant feeding fluid is supplied to the fluid container via the fluid inlet tube. A fluid reservoir is in fluid communication with the distal end of the fluid inlet tube, to provide a source of plant feeding fluid for the container. Also, it is preferred that the fluid reservoir is located above the level of the fluid container, to enable a gravity feed of plant feeding fluid from the reservoir to the fluid container via the fluid feeding tube.

In a method of manufacturing a ceramic fluid device (emitter), according to the present invention, the hollow ball shaped container is produced by providing a ceramic mixture that includes a clay, water and sodium silicate, and providing a casting mold formed of casting plaster. The casting mold is configured to cast a hollow ball shaped container with the configuration of a collar support at its upper end. The ceramic mixture is slip cast in the casting mold, and the slip cast ceramic mixture is fired in a predetermined fashion to produce a predetermined porosity in the ball shaped fluid container. The ceramic collar and fluid inlet tube are sealed to the upper end of the hollow ball shaped container with the fluid inlet tube in fluid communication with the interior of the hollow ball shaped container.

There are two preferred formulations of the ceramic mixture that is used to form the ceramic fluid container. In one formulation, the principal components of the mixture are Laguna 207 dry clay, water and sodium silicate. In another formulation, the principal components of the mixture are Talc, KT ball clay, Custer Velspar Ball Clay, soda ash, water and sodium silicate.

In a preferred version of the method of manufacturing the ceramic emitter, the ceramic collar is produced by providing a preformed collar form, coating the collar form with the slip casting ceramic mixture, and placing the coated ceramic collar form in the collar support at the upper end of the container, such that the coated ceramic collar form when set in the container and fired with the container has a sealed relationship with the collar support at the upper end of the fluid container. The collar form has a central opening to enable the coated collar form to be coupled and sealed to a fluid inlet tube, with the fluid inlet tube in fluid communication with the interior of the ball shaped container.

Other features of the present invention will become further apparent from the following detailed description and the accompanying drawings.

### BRIEF DESCRIPTION OF THE DRAWINGS

FIG. 1 is a three dimensional illustration of a ceramic plant root system feeding device (emitter), according to the present invention;

FIGS. 2, and 3 are side and top views, respectively, of a fluid inlet tube for a plant root feeding system, according to the principals of the present invention;

FIG. 4 is a top view of the ball shaped portion of the ceramic emitter of FIG. 1;

FIG. 5 is a sectional view of the ball shaped portion of the ceramic emitter, taken from the direction 2-2 in FIG. 4, and showing some exemplary dimensions for the emitter;

FIG. 6 is a top view of the ceramic emitter of FIG. 1;

FIG. 7 is a sectional view of the ceramic emitter, taken from the direction 3-3 in FIG. 4, and showing some exemplary dimensions for the emitter;

FIG. 8 is a schematic illustration of a plant root feeding system, in accordance with the present invention;

FIG. 9 is a schematic illustration of a casting mold for casting the ball shaped portion of the ceramic emitter; and

FIG. 10 is a schematic illustration of the manufacture steps in producing the ceramic emitter of the present invention.

### DETAILED DESCRIPTION

As discussed above, the present invention relates to a new and useful (i) plant root feeding device (ii) plant root feeding system, (iii) method of feeding a plant, and (iv) method of manufacturing a plant root feeding device.

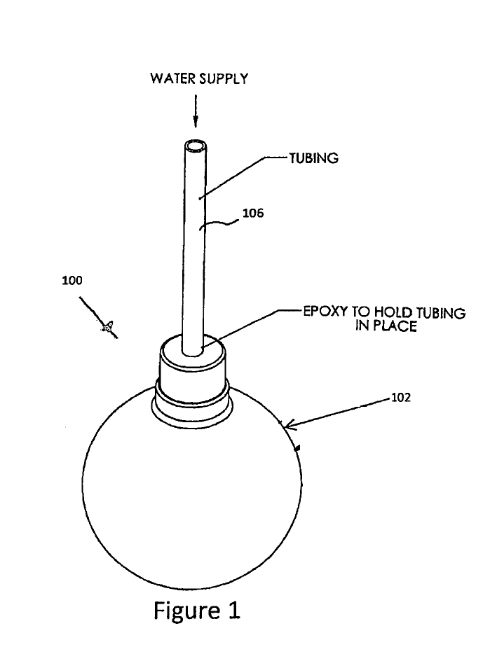

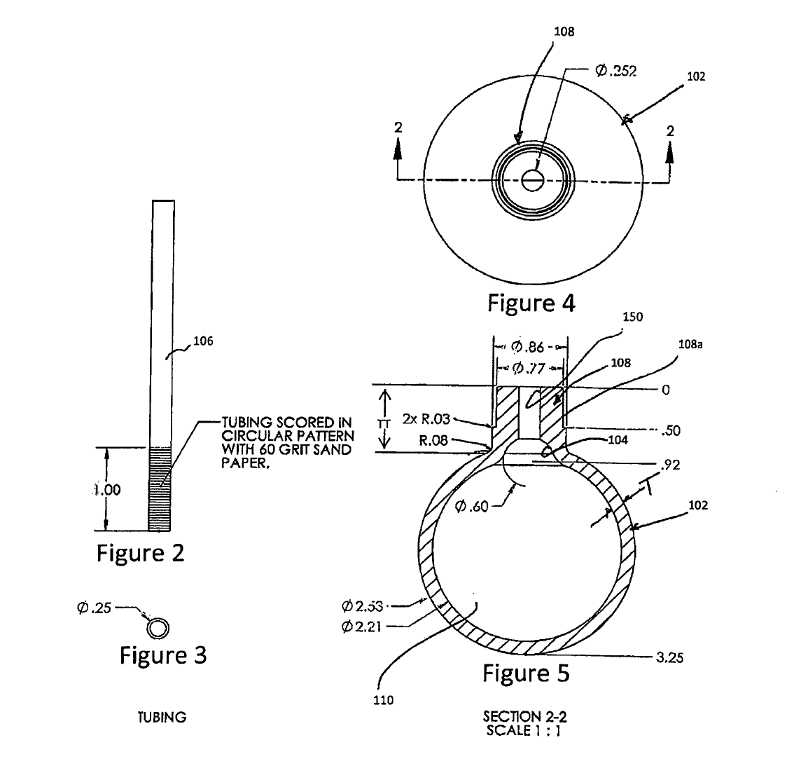

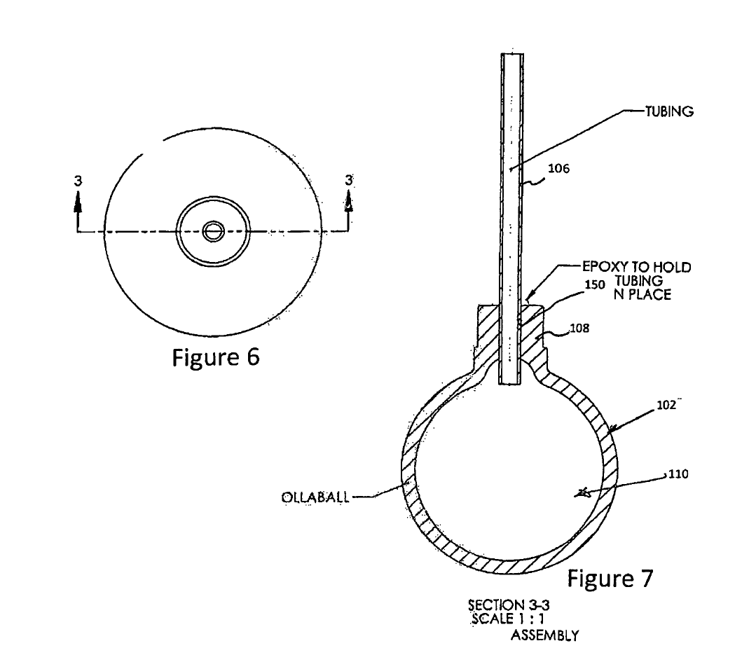

FIGS. 1-7 show the plant root feeding device and the plant root feeding system according to the present invention. The plant root feeding device 100 comprises a fluid container 102 (emitter) formed of semi permeable material that allows fluid to pass from the inside of the container to a plant root system located in ground in proximity to the fluid container. The fluid container 102 has a fluid inlet opening 104, and a fluid inlet tube 106 is in fluid communication with the fluid inlet opening of the fluid container. The fluid inlet tube 106 has a fixed, fluid sealed coupling to the fluid inlet opening 104 of the fluid container, and the fluid container 100 has a configuration that enables it to be located in ground in proximity to an in ground root system of a plant, and a permeability that enables fluid to pass from the inside of the container to the in ground root system of a plant in proximity to the fluid container.

In this application reference to the fluid container (emitter) 100 being in “proximity” to an in ground root system of a plant means that the fluid container is within 5 inches of the in ground root system of the plant. Also, the term “plant” encompasses flowers, trees or any other sort of that would have an in ground root system that needs fluid to grow and survive.

In a plant root feeding device according to the present invention, the fluid container (emitter) 100 preferably has a ball shaped configuration (see e.g. FIGS. 1, 5, 7). Also, the fluid container is formed of semi permeable ceramic material. Moreover, the fluid inlet opening 104 has a ceramic collar 108 that has a sealed, substantially permanent connection with the fluid inlet opening 104 of the fluid container (see e.g. FIG. 5), and the fluid inlet tube 106 is integrally connected with the ceramic collar 108, and is in fluid communication with the hollow interior 110 of the fluid container 102 (see e.g. FIG. 7). In addition, the ceramic container 102 has a predetermined wall thickness T (FIG. 5), and the ceramic collar 108 has a thickness TT that is larger than the predetermined wall thickness T of the ceramic container. The ball shaped container 102 is preferably circular in cross section (see FIG. 5) with an outer diameter in the range of 1.5 inches to 5 inches and a wall thickness T in the range of 0.25 inches to ½ inches, and the ratio of the outer diameter of the container to the wall thickness is about 20 to 1. The ceramic material is barium free, and the ceramic material is formed from a clay mixture that includes sodium silicate as a deflocculating agent.

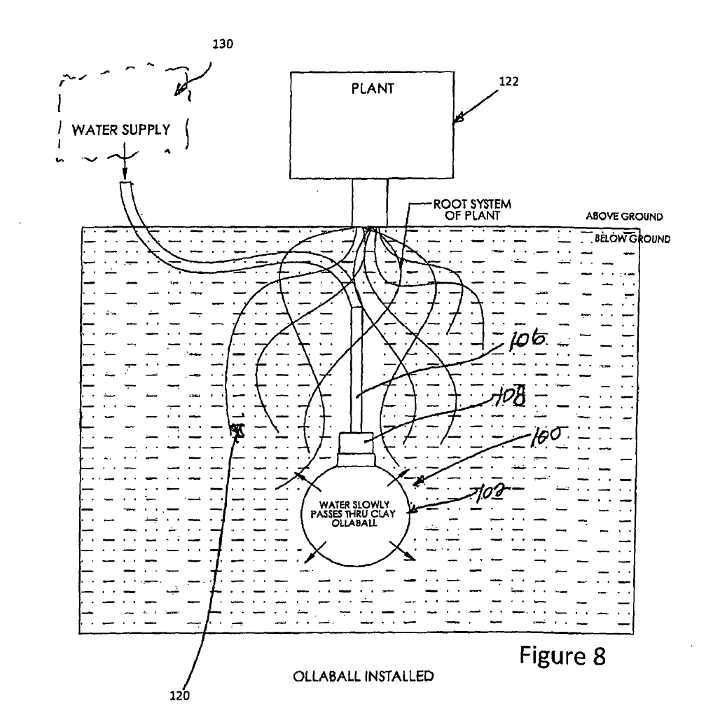

As seen from FIG. 8, in a plant root feeding system according to the present invention, the fluid container (emitter) 102 is located in proximity to the in ground root system 120 of a plant 122. The fluid container is semi permeable and allows fluid to pass, e.g. by osmotic pressure, from the hollow interior 110 of the container to the in ground root system 120 of the plant. The fluid inlet tube 106, which is supported in the collar 108, is in fluid communication with the hollow interior of the ceramic container and extends upward from the container, and has a distal end in fluid communication with a source 130 of plant feeding fluid. The source 130 of plant feeding fluid can be, e.g. a fluid reservoir. The plant feeding fluid can be water, or water combined with nutrients that are desirable, or necessary, for healthy plant growth and sustenance.

There are two preferred formulations of the mixture that is used to form the ceramic fluid container 102. In one formulation, the principal components of the mixture are Laguna 207 dry clay, water and sodium silicate. In another formulation, the principal components of the mixture are Talc, KT ball clay, Custer Velspar Ball Clay, soda ash, water and sodium silicate. In each formulation, the sodium silicate is a deflocculating agent. Also, it should be noted that the formulations, and the ceramic container produced from the formulation, are free of barium.

The method of feeding a plant root system, according to the present invention, can be appreciated from FIG. 8. In a method of feeding a plant root, according to the present invention, the plant root feeding system, as described above, is provided as shown in FIG. 8, with the fluid container is located in proximity to the in ground root system 120 of the plant 122. Plant feeding fluid is supplied to the fluid container from the source (reservoir) 130 via the fluid inlet tube 106, as shown in FIG. 8. The fluid reservoir 130 is in fluid communication with the distal end of the fluid inlet tube 106, to provide a source of plant feeding fluid for the container. Also, it is preferred that the fluid reservoir 130 is located above the level of the fluid container, to enable a gravity feed of plant feeding fluid from the reservoir to the fluid container via the fluid feeding tube.

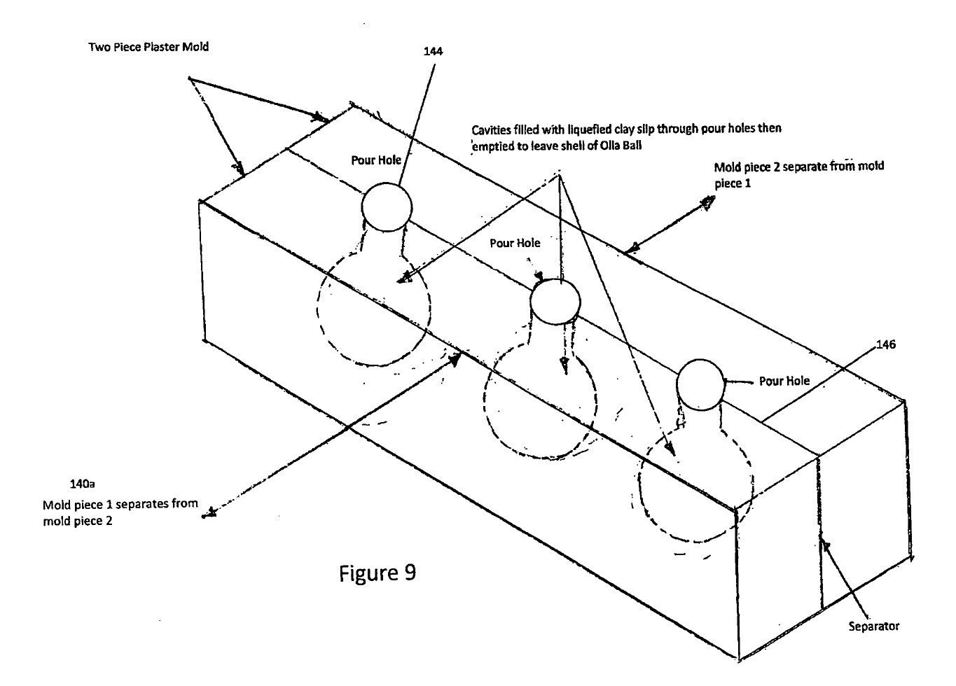

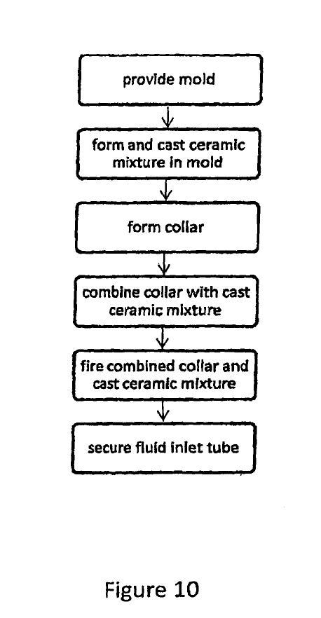

The method of manufacturing the ceramic fluid emitter, according to the principles of the present invention, can be appreciated from FIGS. 5, 9 and 10. The hollow ball shaped container is produced by providing a ceramic mixture that includes a clay, water and sodium silicate, and providing a casting mold formed of casting plaster. The casting mold is formed in two halves 140a, 140b, and is configured to cast a hollow ball shaped container with an inlet opening having the configuration of a collar support 142 at its upper end. The casting mold has several mold cavities, each of which is configured to cast an exact replica of the container 102 shown in FIG. 5, and the collar support is the replica of the collar support surface 108a shown in FIG. 5. The casting mold walls preferably are preferably coated with multiple coats of nitrocelulous lacquer, as a release coating. The ceramic mixture is slip cast in the casting mold, and the slip cast ceramic mixture (with the collar 108) is fired in a predetermined fashion to produce a predetermined porosity in the ball shaped fluid container 102. The ceramic fluid inlet tube 106 is then sealed to the collar 108 at the upper end of the hollow ball shaped container with the fluid inlet tube 106 extending through the collar 108 and the fluid inlet opening, and in fluid communication with the hollow interior 110 of the ball shaped container.

In a preferred version of the method of manufacturing the ceramic emitter, the ceramic collar 108 is produced by providing a preformed collar form (e.g. from plastic or any other suitable material), coating the collar form with the slip casting ceramic mixture, and placing the coated ceramic collar form in the collar support at the inlet opening at the upper end of the container, such that the coated ceramic collar form when set in the container and fired with the container has a sealed relationship with the collar support at the upper end of the fluid container. The collar form has a central opening 150 to enable the coated collar form to be coupled and sealed to the fluid inlet tube, with the fluid inlet tube extending through the collar and in fluid communication with the hollow interior of the ball shaped container.

As described above, there are two preferred ceramic clay formulations for use in producing the ceramic emitter according to the present invention. One formulation uses Terra Cotta Clay. The other formulation uses White Clay.

More specifically, as an example, the formulation using Terra Cotta clay has as its primary ingredients, 300 pounds Laguna 207 dry clay., 23 pounds of H20, and 16 to 32 ounces of sodium silicate that is used to deflocculate the clay as needed. As another example, the formulation using White clay, has as its primary ingredients, 150 pounds of Talc, 100 pounds of KT ball clay, 50 pounds of Custer Velspar Ball clay, 86 grams of Soda Ash, 23 pounds of H2O, and 16 to 32 ounces of sodium silicate that is used to deflocculate the clay as needed.

When the clay is slip cast to the desired shape, it is then fired to complete the ceramic emitter. The firing schedule is predetermined based on the desired porosity of the ceramic emitter. As an example, firing schedules for both clays, are as follows:
a. For a less porous lower water emission: The ceramic emitter is fired in an electric kiln to cone 04 at 1942 degrees Fahrenheit.
b. For a medium porous medium water emission: The ceramic emitter is fired in an electric kiln to cone 05 at 1888 degrees Fahrenheit.
c. For the most porous and highest water emission: The ceramic emitter is fired in an electric kiln to cone 06 at 1828 degrees Fahrenheit.
The manufacturing process in the making of the mold to make the emitter is as follows:
a. The casting molds are made of casting plaster, that is the geometric opposite of the part (i.e. the casting molds are the geometric opposites of the part shown in FIG. 5).
b. The casting mold part is 140a, 140b are made of a hydrostone cement master. Both mold parts have male and female portions that produce molded male and female molded portions that mate the two casting molds for maximum sealing during casting. The master mold is an exact replica of the part, in 2 halves, dividing the ball with collar, directly down the middle of the ball with the collar at the top. At the top of the collar there is a pour hole 144 to allow the clay slip to fill the ball. The master mold parts 140a, 140b are placed side by side on a level, solid, non stick surface, such as a laminate counter top. Mold forms are placed and clamped in a square around the master mold formed by the mold parts 140a, 140b. A plastic divider 146 is placed between the mold formed by the mold parts 140a, 140b to create the 2 casting mold parts leaving a quarter inch of space at either end to allow plaster to flow and fill both mold parts at once. For a casting mold that can produce 3 emitters at once, 7 pounds of dry casting plaster is mechanically mixed with 5 pounds of H2O. The mixture is then immediately poured into the mold form containing both halves of the cement master molds. Once the plaster is solid and starts to get warm to the touch, the mold forms are pulled away from the 2 master and casting mold parts 140a, 140b. At this point, the master and casting molds are ready to be separated. Once separated, the male and female portions of the molded cast halves of the molded containers are slightly pressed together and set to dry into the molded containers. Once dry the molded containers are ready to use for slip casting the ceramic part of the emitter.

The manufacturing process in the making of the ceramic part of the emitter is as follows (the materials, equipment described herein are exemplary as applicants preferred equipment and materials):

Equipment Needed:
a. Slip tank table with mixer, clay pump, hose and gas pump style filler nozzle.
b. Casting molds.
c. Slab roller fitted with coarse canvas.
d. ¾″ clay hole cutter.
e. ¼″ clay hole cutter.
f. Small artist paint brush.
g. Fine sanding pad.
h. Ceramic kiln.
i. Sponge
j. Water bowl

Materials Needed:
k. Clay mixes as described above in the clay formulations.
l. Ready made, solid wet clay blocks, with similar characteristics, as slip formulas described above in clay formulations.

Mixing Clay Process:
m. Add 17 gallons of water and half of the sodium silicate to slip tank including soda ash if applicable.
n. Turn on mixer and let mix for 30 minutes.
o. Add 1 bag of clay to mixing tank at a time, until all solids are liquefied.
p. Add talc one bag at a time, in the same fashion, if applicable. Continue this process until slip has a consistency of thinned pancake batter. Adjust liquid ingredients as needed.
q. Continue mixing for 3 hours. Let slip stand for 24 hours. After 24 hours, turn on mixer, and adjust liquid ingredients, as necessary. Continue to mix for 2 hours.

Casting Process for the Ceramic Part of the Emitters is as Follows:
r. Place four to six mated casting molds together flat, on slip tank table, with pour holes up, and secure them together with a mold strap. Turn on mixer, and clay pump.
s. Using gas pump style filler nozzle, fill all molds with clay slip. Let sit and monitor fill levels, topping off as necessary.
t. After one hour, turn molds upside down and let drain for 5 minutes. A tool or small straw may be needed to open up the pour holes, to facilitate complete drainage.
u. Turn upright and let molds sit. When clay feels to be firm, release mold strap, and separate molds from one another. Scrape excess clay from top of mold pour holes.
v. Let molds sit unopened, until there is a 1/16 gap between the clay around the pour hole and the casting mold.
w. At this point, it is time to check for proper mold release from part. Turn mold, long side down, with pour hole pointed away. Gently lift one half of mold straight up. If mold does not separate easily, allow more dry time. Pulling too soon will destroy the part.
x. Once mold halves are successfully separated, parts can be extracted. Gently pull part from mold, and pull excess pour hole clay from part. Place parts on foam egg crate and cover with plastic until collar installation.

Ceramic Collar Manufacturing Process:
y. This process involves the use of the slab roller, the block clay, a wire clay cutter, and the ¾″ hole cutter.
z. Set slab roller to a thickness, of ⅝″ thickness. Cut block clay into the longest, and widest, strips of the block to ¾″ thick. Place strips on slab roller and roll strips out to reach a thickness of ⅝″ thick.
aa. Using hole cutter, cut out disks, and place in a moist, foam lined, sealed container until ready to install.

Ceramic Collar, and Feed Tube Insertion Hole, Installation Process:
bb. This process involves the wet ceramic slip casted balls, prefabricated collars, artist brush, wet slip and ¼″ hole cutter.
cc. Pour slip into a flat bottomed container, and fill with slip to a ⅛″ thick layer.
dd. Take one collar at a time and dip one collar into slip. Place collar on pre-casted ball.
ee. Using artist brush, dip brush in to slip and seal connection between ball and collar.
ff. Place ball on foam eggcrate and let sit until collar is firmly attached to ball.
gg. When the collar has set to a point of a firm, leather like consistency, use the ¼ clay hole cutter, and push into top center of collar until full penetration into ball, is achieved. Let dry at least 24 hours or until assembled emitters are not cold to the touch, and has little to no moisture content, as destruction can destroy the part in the firing process.

Drying, Cleaning, and Firing Process for Assembled, Ceramic Part of Emitter:
hh. This process, involves the sanding sponge, sponge, water bowl, and kiln.
ii. After assembled ceramic part is thoroughly dried, the part must be cleaned of dangerous or undesirable flaws, such as part lines.
jj. Using the sanding sponge, sand off part lines, as not to sacrifice the integrity of the wall thickness of the part.
kk. Using the sponge and water sparingly, wipe the ball clean of any unsightly textures. Do not disturb the texture of the top of the collar, as this will sacrifice the adhesion of the bind between the top of the collar and the plastic feeder tube.
ll. At this point, the assembled emitters can be loaded into the kiln without the use of kiln shelves or stilts. The assembled parts can be filled to maximum capacity in any sized kiln. Set kiln to desired cone temperature. Turn on kiln and allow to fire. Kiln must never be opened or stopped during the firing cycle and allowed to cool to room temperature, or surrounding temperature of shop space. As the parts integrity, can be sacrificed.

Final Assembly of Ceramic Emitter is as Follows:

Materials Needed for Final Assembly of Ceramic Emitter:
mm. Plastic irrigation tubing
nn. Finished ceramic emitter part.
oo. 2 part epoxy such as JB Weld
pp. 60 grit emory cloth
qq. Vinegar
rr. Mixing cup
ss. Mixing stick (popsicle stick)

Plastic Feeder Tube Preparation and Installation to Ceramic Part of Emitter:
tt. The top part of the collar must be dry, free of residue, and have as much texture, or “tooth” for the adhesive to bond. The weak point is the bond of the feeder tube to the ceramic part of the emitter.
uu. Cut lengths of plastic tubing to desired length, for application needed, to connect to main feed line of H2O.
vv. Sand the end of the plastic tube in a circular motion on the last 1½″ of feeder tube.
ww. Soak feeder tube length in 1 part vinegar and 3 parts water for 30 minutes, rinse, and allow to dry.
xx. Mix epoxy in mixing cup. Apply epoxy liberally, to the full sanded surface of feeder tube.
yy. Insert feeder tube into hole into top of ceramic emitter part. Move feeder tube in and out in a ¼″ movement as to seat the tube and adhesive to the ceramic part.
zz. Finish with adhesive around the top of the collar and create a slope of adhesive from the outer top edge of the collar to ¼″ inch up the feeder tube.
aaa. Allow to dry 24 hours before use or packaging.

There are aspects of the applicants' invention that are believed to go against conventional wisdom in the ceramic arts, particularly in the state of Arizona. For example, in producing the wall thickness of the emitter, according to one preferred formulation, applicants use a clay formulation with Custer Velspar, in place of 50 pounds more of talc in a 300 pound batch of clay. Also, applicants use sodium silicate as a deflocculating agent in a manner which, if not used in the manner described herein, can ruin an entire batch of clay. Also, while it is common for clay to use barium, applicants clay is barium free, and applicants closely monitor the addition of sodium silicate, which does 2 main things; it seals and preserves the integrity of the inside mold surface, as well as yielding a thicker wall thickness of the molded. Also, the formulation of the mold plaster is also important, and in applicants experience goes against common wisdom in the ceramic arts. Specifically, the standard for making a ceramic mold is to use potter's plaster #1, whereas applicants use 20 minute casting plaster, which has no correlation to the ceramic community. The 20 minute casting plaster is widely used in the building industry, and not in the ceramic industry. The difference between the two is the potter's plaster #1 would be problematic in achieving the wall thickness needed in the ball shaped emitter as it does not pull the moisture from the clay as fast as the 20 minute casting plaster. Still further, in applicants the mold making process, when applicants prepare the master to make a plaster casting mold, applicants go against common wisdom in the ceramic arts in that it is common to use mold soap, as a mold release on the master, but applicants use multiple coats of nitrocelulous lacquer on the master mold.

Thus, from the foregoing description, those in the art will appreciate how to manufacture and use a new and useful plant root system feeding device, that can efficiently and economically feed a plant root system.

With the foregoing disclosure in mind, it is believed that various adaptations of a plant root feeding device, system and method of making and using the plant root feeding device, according to the principles of the present invention, will be apparent to those in the art.

1. A plant root feeding device comprising:
a) A container being permeable to water and having a single opening, said container being adapted to be buried proximate to roots of a plant; and,
b) A tube secured at one end to the single opening of the container, an opposing second end being accessible above a ground level.
